(19) United States
(12) Patent Application Publication
(10) Pub. No.: US 2013/0154627 A1
(43) Pub. Date: Jun. 20, 2013

(54) ROTARY ACTUATOR

(71) Applicant: Klaus Pfenning, Waldems (DE)

(72) Inventor: Klaus Pfenning, Waldems (DE)

(73) Assignee: Continental Automotive GmbH, Hannover (DE)

(21) Appl. No.: 13/818,920

(22) PCT Filed: Aug. 24, 2011
(86) PCT No.: PCT/EP11/64513

§ 371 Date: Feb. 25, 2013

(30) Foreign Application Priority Data
Aug. 31, 2010 (DE) 10 2010 036 006.6

(51) Int. Cl. G01B 7/30

(52) U.S. Cl. CPC G01B 7/30
USPC 324/207.25

(57) ABSTRACT

A rotary actuator has a handle, rotatable about an axis of rotation, and a position sensor system for detecting the rotary position of the handle. The rotary actuator has an actuating segment is made of an electrically conductive material and, forming a capacitor, is opposite a sensor segment of a stationary segment ring, which is concentric with respect to the axis of rotation 3 and consists of a plurality of sensor segments. The sensor segments include an electrically conductive material and are axially spaced apart by an air gap. A sensor line leads from each sensor segment to evaluation electronics.

### PRIORITY CLAIM

This is a U.S. national stage of PCT International Application No. PCT/EP2011/064513, filed on 24 Aug. 2011, which claims priority to German Application No. 10 2010 036 006.6, filed 31 Aug. 2010, the contents of which are incorporated herein by reference in its entirety.

### BACKGROUND OF THE INVENTION

1. Field of the Invention

The present invention relates to a rotary actuator having a handle which is rotatable about an axis of rotation, and a position sensor system for detecting the rotary position of the handle.

2. Description of the Related Art

In the case of such rotary actuators, it is known to carry out the detection of the rotary position of the handle with potentiometers, encoders, light barriers or Hall sensors.

These rotary position detections are complicated and expensive.

### SUMMARY OF THE INVENTION

It is therefore an object of the present invention to devise a rotary actuator which has a simple and inexpensive structure.

According to the present invention, this object is achieved in that the handle has, at the end thereof which faces away from an operating side of the handle and consists of an electrically non-conductive material, at a radial distance from the axis of rotation, an actuating segment which is made of an electrically conductive material and, forming a capacitor, is opposite a sensor segment of a stationary segment ring. The ring is concentric with respect to the axis of rotation and including of a plurality of sensor segments which are uniformly distributed on the periphery of the segment ring, are spaced apart from one another in the circumferential direction and are made of an electrically conductive material, in a manner axially spaced apart by an air gap. A sensor line leads from each sensor segment to evaluation electronics.

In a non-contacting and therefore wear-free manner, the capacitance between the sensor element and the sensor segment which is located exactly opposite the sensor element changes, and is fed to the evaluation electronics as a sensor signal. This sensor signal is assigned by the evaluation electronics to a specific rotary position of the handle and a corresponding indication signal is supplied to an indicator.

Since the sensor signal is generated without the supply of energy, the structure of the rotary actuator is simple and requires few parts, which means that the overall height can also be kept low.

The handle can have a marking at the end thereof on the operating side.

In order to be able to detect the rotary position assumed by the rotary actuator without rotating the handle, the handle can have, in the edge region of the end thereof on the operating side, a marking formed as an index marking.

It can be produced particularly simply by injection molding if the handle is a plastic part and the actuating segment consists of a conductive plastic.

It leads to a good change in capacitance as the handle is rotated if the sensor segments are copper segments.

It can be produced particularly inexpensively if these sensor segments are copper areas applied to a printed circuit board.

In order to be able to generate a high number of sensor signals per revolution of the handle and therefore to achieve a high resolution of the rotary positions, the sensor segments can form a first segment ring with a plurality of groups following one another in the circumferential direction and having an equal number of first sensor segments and, radially inside or outside the first segment ring, a second segment ring with second sensor segments can be arranged to be stationary, which form groups following one another in the circumferential direction and having an equal number of sensor segments, wherein in each case a first sensor segment is assigned a second sensor segment located radially opposite, and the actuating segment is always located opposite a first and the second sensor element assigned thereto, and wherein the first sensor segments of the same position of the groups of the first segment ring are connected to a common input of the evaluation electronics, and the second sensor segments of the same group of the second segment ring are respectively connected to a common further input of the evaluation electronics.

Therefore, via a few sensor lines, a relatively large number of sensor signals can be fed to the evaluation electronics.

It leads both to a saving in materials and also to the creation of space for further components if the handle is of pot-like form and, at the end thereof on the operating side, is closed by a base.

The base can have translucent regions forming symbols and/or markings, and a stationary light source can project from the side facing away from the operating side into the pot opening of the handle, by which means the symbols and/or markings like, for example, the index marking, can be illuminated and thus detected rapidly.

In a simple embodiment, the light source can be arranged on the printed circuit board in this case.

In order to be able to detect the rotation from one rotary position to a next rotary position by touch as well, and in order to achieve an optimal overlap of the actuating segment with the respective sensor element of the rotary position assumed, the handle can be rotatable in latching steps, wherein the number of latching steps corresponds to the number of sensor segments of the segment ring and the actuating segment is located opposite a sensor segment in every latching position.

### BRIEF DESCRIPTION OF THE DRAWINGS

FIG. 1 shows a longitudinal section of a first exemplary embodiment of a rotary actuator.

FIG. 2 shows a plan view of the rotary actuator according to figure I.

FIG. 3 shows a longitudinal section of a second exemplary embodiment of a rotary actuator.

FIG. 4 shows a plan view of the rotary actuator according to FIG. 3.

FIG. 5 shows a plan view of a segment ring of the rotary actuator according to FIGS. 1 to 4.

FIG. 6 shows a plan view of a first and second segment ring of a third exemplary embodiment of a rotary actuator.

### DETAILED DESCRIPTION OF THE PREFERRED EMBODIMENTS

The rotary actuators of the exemplary embodiments have a pot-like handle 4 rotatable about an axis of rotation 3 in a recess 1 in a front panel 2.

On the operating side, the handle 4 closed by a base 5 projects from the front panel 2 and can be gripped and rotated by an operator.

At the end thereof opposite to the base 5, the handle 4 is formed with a ring-like collar 6 extending radially outward.

The handle 4 including collar 6 is an injection molded part.

Injection molded into the collar 6 at the same time is an actuating segment 7 made of conductive plastic.

Arranged spaced apart from the collar 6 by an air gap forming a dielectric is a printed circuit board 9, which bears a segment ring 10 made of sensor segments 11 formed on the printed circuit board 9 as applied copper areas.

The sixteen sensor segments 11 are arranged distributed uniformly at distances 12 from one another on the circumference of the segment ring 10 that is concentric with respect to the axis of rotation 3.

Not illustrated in FIGS. 1 to 4, a sensor line 13 leads from each sensor segment 11 to evaluation electronics 14, by which indicating elements 18 can then be activated in accordance with the assumed rotary position of the handle 4.

Arranged on the printed circuit board 9, coaxially with respect to the axis of rotation 3, is a light source 15, which projects into the pot opening 16 of the handle 4.

In the exemplary embodiment of FIGS. 1 and 2, the base 5 of the otherwise non-translucent handle 4 is designed to be translucent, so that it forms a luminous circular disk when the light source 15 is switched on.

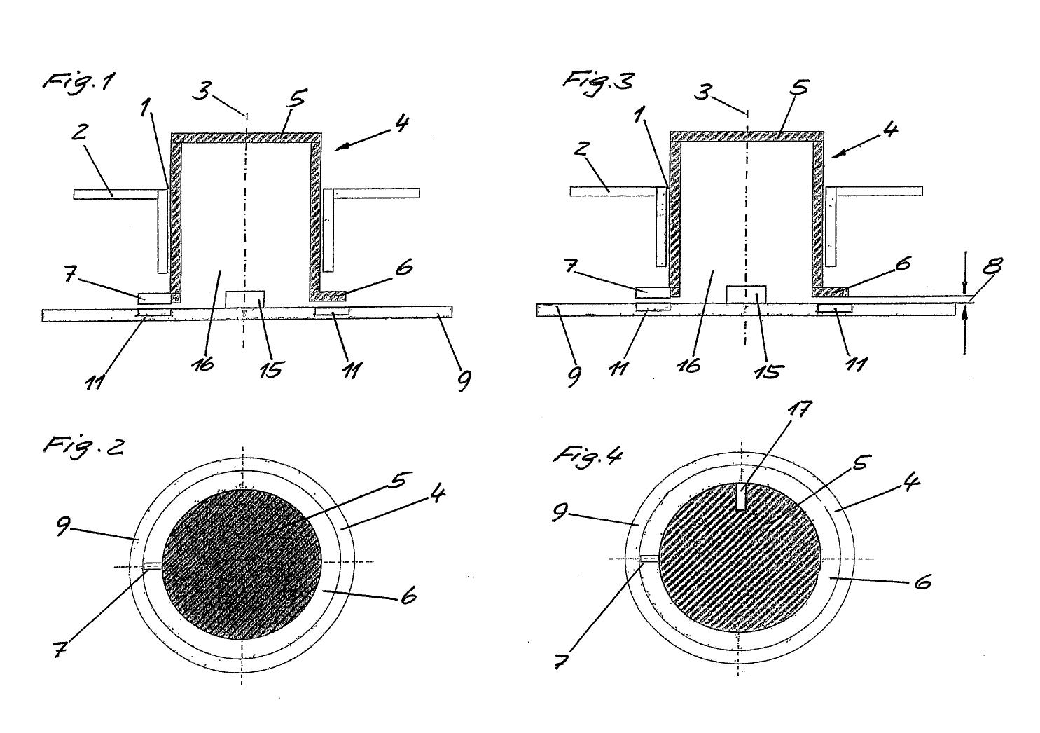

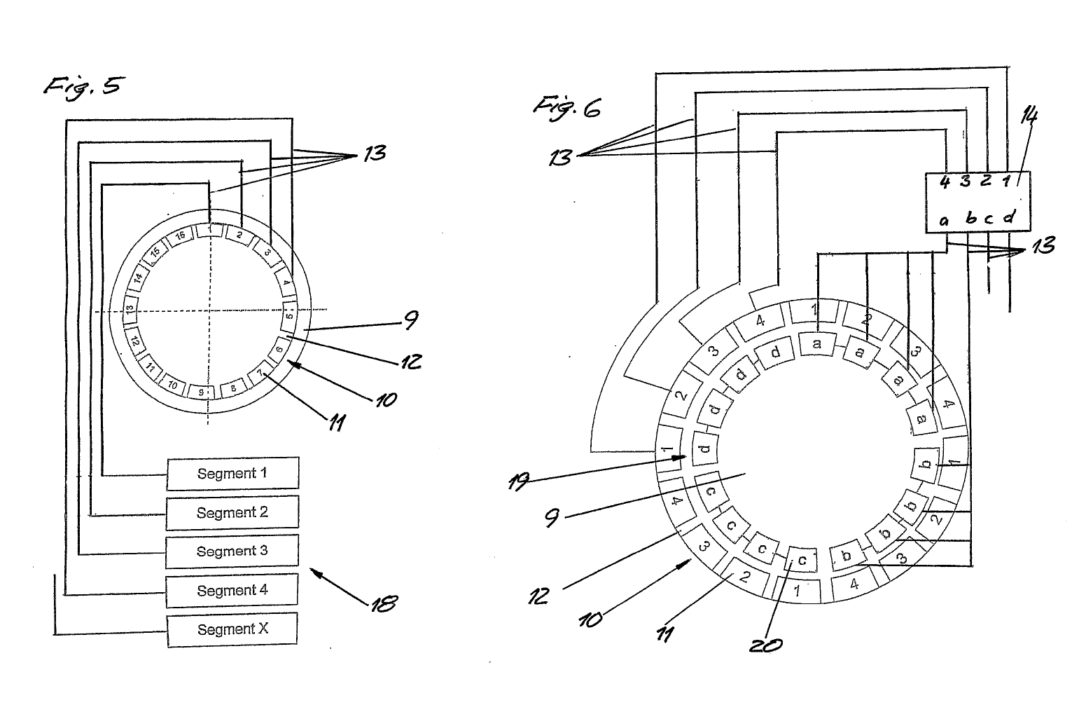

In the exemplary embodiment of FIGS. 3 and 4, the base 5 and also the entire handle 4 is non-translucent apart from an index marking 17 in the edge region of the base 5.

When the light source 15 is switched on, the index marking 17 is thus illuminated and provides an operator with information about the instantaneous rotary position of the handle 4.

In the exemplary embodiment of FIG. 6, the segment ring 10 has four groups each of four segments 11, which are designated by 1, 2, 3 and 4 and lead via sensor lines 13 to corresponding inputs of the evaluation electronics 14.

Radially within the segment ring 10, concentrically with respect to the axis of rotation 3, a second segment ring 19 is arranged on the printed circuit board and, in the same way as in the case of the first segment ring 10, consists of four groups each of four second sensor elements 20.

All the sensor segments 20 of a group a, b, c, or d are led via sensor lines 13 to an input of the evaluation electronics 14 that is assigned to this group.

The sensor elements 11 and 20 of the first segment ring 10 and of the second segment ring 19 are assigned radially to one another in such a way that in each case a sensor element 11 and a sensor element 20 can be covered jointly by the actuating segment 7 and both feed a sensor signal to the evaluation electronics 14.

In this way, sixteen sensor signals can be evaluated with only eight inputs of the evaluation electronics 14.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A rotary actuator, comprising:
a handle rotatable about an axis of rotation;
a position sensor system for detecting a rotary position of the handle;
an actuating segment located at an end of the handle facing away from an operating side of the handle and at a radial distance from the axis of rotation, the end of the handle including an electrically non-conductive material, wherein the actuating segment includes a first electrically conductive material and forms a capacitor;
a stationary segment ring including a plurality of sensor segments uniformly distributed on a periphery of the segment ring and being concentric with respect to the axis of rotation, wherein:
the actuating segment is located opposite the sensor segments,
the sensor segments are spaced apart from one another in a circumferential direction and are made of a second electrically conductive material, and the sensor segments are spaced apart from the handle by an air gap; and
a respective sensor line leading from each sensor segment to evaluation electronics.

12. The rotary actuator as claimed in claim 11, wherein the handle includes a marking in an end region of an end on the operating side of the handle.

13. The rotary actuator as claimed in claim 11, wherein:
the handle includes a plastic part, and the actuating segment includes a conductive plastic.

14. The rotary actuator as claimed in claim 11, wherein the sensor segments are copper segments.

15. The rotary actuator as claimed in claim 14, further comprising:
a printed circuit board, wherein the sensor segments are copper areas applied to the printed circuit board.

16. The rotary actuator as claimed in claim 11, wherein:
the sensor segments form a first segment ring having a plurality of groups following one another in the circumferential direction and having an equal number of first segment segments,
one of radially inside and outside the first segment ring, a second segment ring with second sensor segments is arranged to be stationary,
the first segment ring and the second segment ring form groups following one another in the circumferential direction and have an equal number of sensor segments,
in each case a first sensor segment is assigned a second sensor segment located in a radially opposite manner,
the actuating segment is always located opposite a first sensor segment and a second sensor segment assigned thereto,
the first sensor segments of the same position of the groups of the first segment ring are connected to a common input of the evaluation electronics, and
the second sensor segments of the same group of the second segment ring are respectively connected to a further common input of the evaluation electronics.

17. The rotary actuator as claimed in claim 15, wherein:
the handle is of a pot-like form, and at an end of the handle on the operating side thereof, the handle is closed by a base.

18. The rotary actuator as claimed in claim 17, wherein:
the base includes translucent regions forming at least one of symbols and markings, and a stationary light source projects from the end of the handle facing away from the operating side into a pot opening of the handle.

19. The rotary actuator as claimed in claim 18, wherein the light source is arranged on the printed circuit board.

20. The rotary actuator as claimed in claim 11, wherein:
the handle is rotatable in latching steps,
a number of latching steps corresponds to a number of sensor segments of the segment ring, and
the actuating segment is located opposite a respective sensor segment in every latching position corresponding to the latching steps.
